(19) United States
(12) Patent Application Publication
(10) Pub. No.: US 2026/0245946 A1
(43) Pub. Date: Aug. 20, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventors: Jae Wook LEE, Yongin-si (KR); Sung Sub SONG, Yongin-si (KR)

(21) Appl. No.: 19/240,106

(22) Filed: Jun. 17, 2025

(30) Foreign Application Priority Data
Feb. 20, 2025 (KR) 10-2025-0021918

(51) Int. Cl. H01M 10/04; H01M 10/42

(52) U.S. Cl. CPC H01M 10/045; H01M 10/4235

(57) ABSTRACT

An electrode assembly according to an embodiment comprises a first unit cell comprising a plurality of insert portions formed by a plurality of bent portions; and second unit cells provided to the insert portions. The first unit cell comprises a second(a) electrode as a negative electrode and a separator disposed on both surfaces of the second(a) electrode. Each of the second unit cells comprises a plurality of first electrodes as positive electrodes, at least one second(b) electrode as a negative electrode, and a plurality of separators. The second unit cells have a thickness of 0.3 mm to 0.5 mm.

### CROSS-REFERENCE TO THE RELATED APPLICATION

The present application claims priority to and the benefit of Korean Patent Application No. 10-2025-0021918, filed on Feb. 20, 2025, in the Korean Intellectual Property Office, the entire disclosure of which is incorporated herein by reference.

### BACKGROUND

### 1. Field

Embodiments relate to an electrode assembly and a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a safer secondary battery having improved safety.

Embodiments provide a secondary battery that may be easily manufactured.

An electrode assembly according to an embodiment comprises a first unit cell comprising a plurality of insert portions formed by a plurality of bent portions; second unit cells, each of which is provided to one of the insert portions, the first unit cell comprises a second(a) electrode as a negative electrode and a separator disposed on both surfaces of the second(a) electrode, the second unit cell comprises a plurality of first electrodes as positive electrode, at least one second(b) electrode, and a plurality of separators, and the second unit cell has a thickness of 0.3 mm to 0.5 mm.

A radius of curvature of the bending portion is 0.15 mm to 0.25 mm.

The shapes of the separator of the first unit cell and the separators of the second unit cells are different.

The separator of the first unit cell and the separators of the second unit cells comprise different materials.

The separator of the first unit cell and the separators of the second unit cells have different thicknesses.

The second(a) electrode and the second(b) electrodes comprise different materials.

The second(a) electrode and the second(b) electrodes have different thicknesses.

The second(a) electrode comprises a current collector and an active material layer disposed on surfaces of the current collector, the current collector comprises a straight portion and a bent portion, and the active material layer is disposed on the straight portion.

The active material layer is disposed in a part of the bent portion.

The second(a) electrode comprises a current collector; and an active material layer disposed on surfaces of the current collector, the current collector comprises a straight portion and a bent portion, the active material layer is disposed on the straight portion and the bent portion, and the thickness of the second active material layer disposed on the bent portion is less than the thickness of the second active material layer disposed on the straight portion.

The second(a) electrode further comprises a protective layer on the second active material layer that is disposed on the bent portion.

The second(a) electrode comprises a current collector, with an active material layer and a resin layer being formed on surfaces of the current collector, the current collector comprises a straight portion and a bent portion, the active material layer is disposed on the straight portion, and the resin layer is disposed on the bent portion.

An electrode assembly according to an embodiment comprises a plurality of unit cells each including a plurality of first electrodes, at least one second(b) electrode, and a plurality of separators, with the first electrodes being positive electrodes, and a second(a) electrode including a plurality of insert portions formed by a plurality of bent portions, the second electrode(a) being a negative electrode, each of the unit cells being inserted to one of the insert portions of the second(a) electrode, and the thicknesses of the unit cells are 0.3 mm to 0.5 mm.

A radius of curvature of the bending portion is 0.15 mm to 0.25 mm.

The second(a) electrode and the second(b) electrodes comprise different materials.

The second(a) electrode and the second(b) electrodes have different thicknesses.

The second(a) electrode comprises a current collector; and an active material layer disposed on surfaces of the current collector, the second(a) electrode comprises an open region where the active material layer is not disposed, and the second(a) electrode is bent in the open region.

The second(a) electrode comprises a current collector; and an active material layer disposed on surfaces of the current collector, the second(a) electrode comprises a first region and a second region, the active material layer having a first thickness on the first region, the active material layer having a second thickness on the second region, the second thickness is less than the first thickness, and the second(a) electrode is bent in the second region.

The second(a) electrode further comprises a protective layer on the active material layer on the second region.

The second(a) electrode comprises a current collector, and an active material layer and a resin layer being formed on surfaces of the current collector, the second(a) electrode comprises a first region and a second region, the active material layer is disposed on the first region, the resin layer is disposed on the second region, and the second(a) electrode is bent in the second region.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to an embodiment.

FIGS. 2 and 3 are views explaining a method of manufacturing an electrode assembly according to the embodiment.

FIG. 4 is a side view showing the electrode assembly according to the embodiment.

FIGS. 5 to 8 are views explaining various examples of the electrode assembly according to the embodiment.

FIGS. 9 and 10 are views explaining a method of manufacturing the electrode assembly according to another embodiment.

FIGS. 11 to 14 are views explaining various examples of a first electrode of the electrode assembly according to the embodiment.

FIGS. 15 and 16 are perspective views showing a battery pack including secondary batteries according to some embodiments.

FIGS. 17 and 18 are perspective views and a side view showing a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly and a secondary battery according to an embodiment will be described with reference to the drawings.

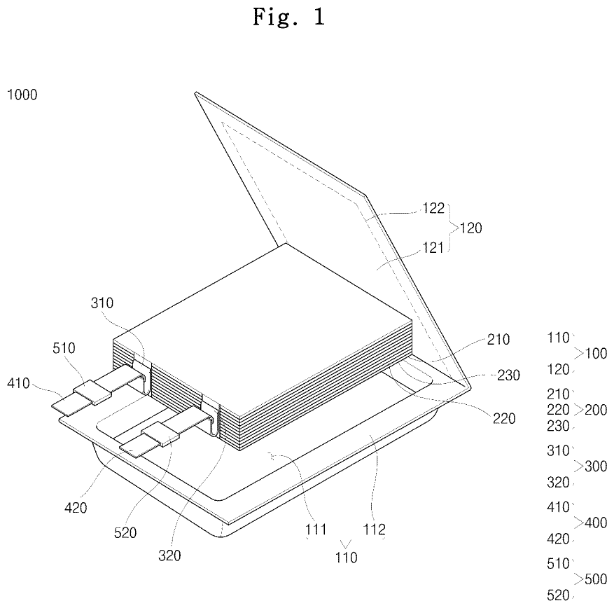

Referring to FIG. 1, the secondary battery according to the embodiment may include a case 100 and an electrode assembly 200.

The case 100 may include an accommodation part 110 and a cap part 120. The accommodation part 110 and the cap part 120 may be connected. And the case 100 may be formed in a pouch shape.

The accommodation part 110 may include a concave part 111 and a first sealing region 112. The accommodation part 110 may include an accommodating space. In detail, the accommodation part 110 may include an internal bottom surface and an inner side surface formed by the concave part 111. The accommodating space may be formed by the bottom surface and the inner side surface.

The first sealing region 112 may be disposed at the edge of the accommodation part 110. A sealing layer may be disposed on the first sealing region 112.

The cap part 120 may include a cover part 121 and a second sealing region 122.

The cover part 121 may cover the accommodation part 110. In particular, the cover part 121 may cover the electrode assembly 200 accommodated in the accommodation part 110.

The second sealing region 122 may be disposed at the edge of the cap part 120. The sealing layer may be disposed on the second sealing region 122. The first sealing region 112 and the second sealing region 122 may overlap each other. In detail, when the accommodation part 110 is covered by the cap part 120, the first sealing region 112 and the second sealing region 122 may face each other. And the accommodation part 110 and the cap part 120 may be bonded by the sealing layer.

The electrode assembly 200 may be accommodated in in the accommodating space of the case 100 The electrolyte may be accommodated in the accommodating space with the electrode assembly 200.

In the depicted embodiment, one electrode assembly is illustrated as being accommodated in the case. However, the present disclosure is not limited thereto. In other embodiments, two or more electrode assemblies may be accommodated in the case.

The electrode assembly 200 may include a first electrode 210, a second electrode 220 and a separator 230.

The first electrode 210 may include a first current collector and a first active material layer on the first current collector. The first current collector may include a metal foil such as aluminum or an aluminum alloy. The first active material layer may include a transition metal oxide. For example, the first electrode 210 may be a positive electrode.

The first electrode 210 may be connected to the first electrode tab 310. The first active material layer is not disposed on the first electrode tab 310. The first electrode tab 310 may be welded to the first current collector on which the first active material layer is not disposed. In other embodiments, the first electrode tab 310 may be formed integrally with the first current collector. For example, the first collector may include a first uncoated portion on which the first active material layer is not disposed. The first uncoated portion may be notched. The first electrode tab 310 may be formed by the first uncoated portion. Therefore, the first electrode tab 310 may be formed from the same material as the first current collector. That is, the first electrode tab 310 may be a substrate tab.

The second electrode 220 may include a second current collector and a second active material layer on the second current collector. The second current collector may include a metal foil such as copper, a copper alloy, nickel, or a nickel alloy. The second active material layer may include graphite or carbon. For example, the second electrode 220 may be a negative electrode.

The second electrode 220 may be connected to the second electrode tab 320. The second active material is not disposed on the second electrode tab 320. The second electrode tab 320 may be welded to the second current collector on which the second active material layer is not disposed. In other embodiments, the second electrode tab 320 may be formed integrally with the second current collector. For example, the second collector may include a second uncoated portion on which the second active material layer is not disposed. The second uncoated portion may be notched. The second electrode tab 320 may be formed by the second uncoated portion. Therefore, the second electrode tab 320 may be formed from the same material as the second current collector. That is, the second electrode tab 320 may be a substrate tab.

The first electrode tab 310 and the second electrode tab 320 may each be connected to a lead. For example, the first electrode tab 310 may be connected to a first external terminal by the first lead 410. The second electrode tab 320 may be connected to a second external terminal by the second lead 420. The first lead 410 may be formed from the same material as the first electrode tab. And, the second lead 420 may be formed from the same material as the second electrode tab. The electrode tabs 310 and 320 and the leads 410 and 420 may be coupled by welding.

An insulating layer may be disposed on the leads. For example, a first insulating layer 510 may be disposed on the first lead 410. More specifically, the first insulating layer 510 may be disposed to surround a portion of the first lead 410. A second insulating layer 520 may be disposed on the second lead 420. More specifically, the second insulating layer 520 may be disposed to surround a portion of the second lead 420. The lead 400 may be insulated from the case 100 by the insulating layer 500. The lead 400 and the case 100 may be easily bonded by the insulating layer 500 and the sealing layer. And the first lead 410 and the second lead 420 may be insulated by the insulating layer 500.

The electrode assembly 200 may be formed in various ways. For example, the electrode assembly 200 may be formed by a winding process, a stacking process, or a lamination process. In a winding process, the first electrode 210, the second electrode 220, and the separator 230 are wound by a winder. In a stacking process, the first electrode 210, the second electrode 220, and the separator 230 are sequentially stacked. In a lamination process, the first electrode 210, the separator 230, and the second electrode 220 are sequentially laminated and then stacked. The stacking process may be a Z-Stack process in which the separator is supplied in a roll form, with the first electrode and the second electrode being inserted to and stacked with the separator.

In terms of mass productivity of the electrode assembly, a winding process may be advantageous. However, in terms of capacity and low resistance of the electrode assembly, the stack process may be advantageous. The lamination process is advantageous in terms of mass productivity and low resistance. However, the lamination process may be a more expensive process. The stack process may be disadvantageous in terms of mass productivity, and, thus, has a lower process efficiency.

Embodiments of the present disclosure may provide a method of manufacturing an electrode assembly capable of improving mass production of the stack process and an electrode assembly manufactured thereby.

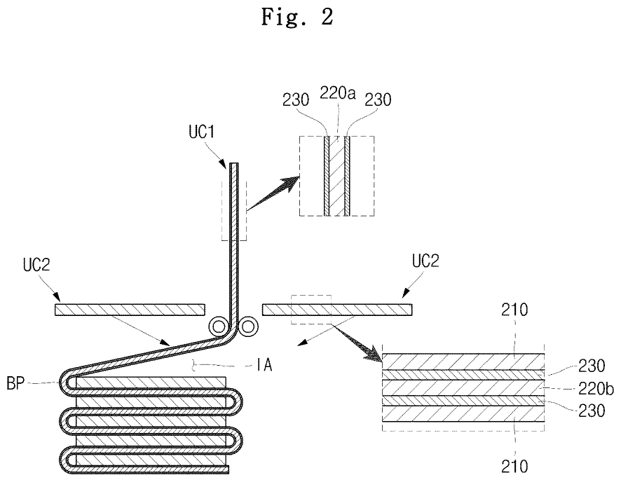

Referring to FIGS. 2 to 8, a method of manufacturing an electrode assembly according to an embodiment and an electrode assembly manufactured thereby are described.

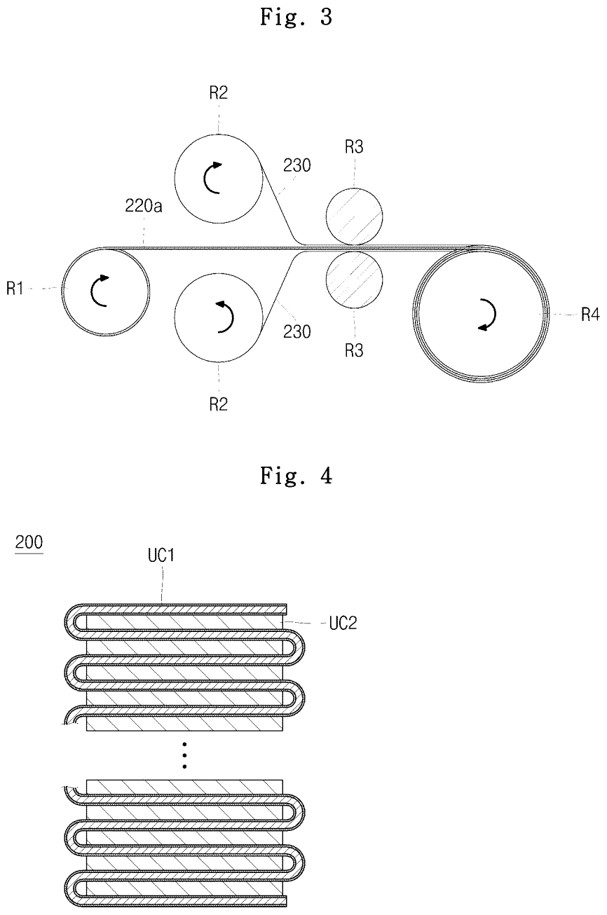

FIGS. 2 and 3 are drawings explaining the method of manufacturing the electrode assembly according to the embodiment.

Referring to FIGS. 2 and 3, a first unit cell UC1 and a second unit cell UC2 are prepared.

The first unit cell UC1 includes the second(a) electrode 220a and the separator 230. The separator 230 is disposed on both surfaces of the second(a) electrode 220a. In a particular embodiment, the separator 230 is laminated on opposite surfaces of the second(a) electrode 220a.

The first unit cell UC1 is wound on a roller. Referring to FIG. 3, the second(a) electrode 220a may be unwound from the first roller R1 and the separator 230 may be unwound from two second rollers R2. The second(a) electrode 220a and the separator 230 are thermally compressed by the third roller R3. Thus, the separator 230 is laminated on both surfaces of the second(a) electrode 220a, thereby forming the first unit cell UC1. The first unit cell UC1 may be wound on the fourth roller R4.

The second unit cell UC2 includes the first electrode 210, the second(b) electrode 220b, and the separator 230. The second unit cell UC2 may have a set thickness. In a particular embodiment, the thickness of the second unit cell (UC2) may be 0.3 mm or more. For example, the thickness of the second unit cell UC2 may be 0.3 mm to 0.5 mm.

The number of layers of the second unit cell UC2 is controlled. In detail, the second unit cell UC2 may include a plurality of first electrodes 210, at least one second(b) electrode 220b, and a plurality of separators 230. The first electrode 210 may be disposed at the lowermost and uppermost portions of the second unit cell UC2, the second(b) electrode 220b may be disposed between the first electrodes 210, and separators 230 may be disposed between the first electrodes 210 and the second(b) electrode 220b.

The first unit cell UC1 is unwound from the fourth roller and formed into a plurality of bent portions BP. as shown in FIG. 3, the second unit cells UC2 may be inserted into insert portions IA formed by the bent portions.

The first unit cell UC1 includes the bent portion BP. The first unit cell UC1 also includes the second(a) electrode 220a. The second(a) electrode 220a includes a second current collector and a second active material layer. The second current collector may be more flexible than the second active material layer. Accordingly, the second collector may be easily bent into the shape of the bent portions BP. On the other hand, the second active material layer is less flexible. Accordingly, the second active material layer may crack if it was a part of the bent portions BP. And the crack may extend to a region other than the bent portion. Therefore, the yield and performance of the electrode assembly may decrease.

The bent portion BP may have a curvature radius within a set range. For example, the curvature radius of the bent portion BP may be 0.15R (mm) or more. More specifically, the curvature radius of the bent portion BP may be 0.15 mm to 0.25 mm.

The curvature radius of the bent portion BP may correspond to the thickness of the second unit cell UC2. That is, the curvature radius of the bent portion BP may be proportional to the thickness of the second unit cell UC2. In example embodiments, the thickness of the second unit cell UC2 may be 0.3 mm to 0.5 mm. When the thickness of the second unit cell UC2 is less than 0.3 mm, the radius of curvature of the bent portion BP may decrease. In such case, the second active material layer in the bent portion BP may crack. When the thickness of the second unit cell UC2 is greater than 0.5 mm, the radius of curvature of the bent portion BP may increase. In a manufacturing process, the first unit cell UC1 may be thermally compressed after the insertion of the second unit cell UC2 is completed. When the radius of curvature of the bent portion BP is increased, the efficiency of the thermal compression process may decrease. And the first unit cell UC1 may be damaged during the extended thermal compression process.

FIG. 4 is the electrode assembly formed by the manufacturing method described above.

The electrode assembly 200 may include separators of different shapes. For example, the electrode assembly 200 may include a first separator of the first unit cell UC1 and a second separator of the second unit cell UC2,

The first separator includes a bent portion, and the second separator does not include a bent portion. The first separator and the second separator may not be connected to each other.

The first separator and the second separator may be formed from the same material. In other embodiments, the first separator and the second separator may be formed from different materials. The first separator may include a material that is more elastic than the second separator. Thus, the first separator may be more flexible than the second separator.

The first separator and the second separator may have the same thickness. In other embodiments, the first separator and the second separator may have different thicknesses. For example, the thickness of the first separator may be less than the thickness of the second separator. Accordingly, the first separator may be more easily bent than the second separator.

The electrode assembly 200 may include second electrodes having different shapes. For example, the electrode assembly 200 may include a second(a) electrode of the first unit cell UC1 and a second(b) electrode of the second unit cell UC2. The second(a) electrode may include a bent portion, and the second(b) electrode may not include a bent portion.

The second(a) electrode and the second(b) electrode may be formed from the same material, or the second(a) electrode and the second(b) electrode may be formed from different materials. In one example, the second current collector of the second(a) electrode may be formed from a material that is more elastic than the material that the second current collector of the second(b) electrode is formed from. In another example, the second active material layer of the second(a) electrode may be formed from a material that is more elastic than a material that the second active material layer of the second(b) electrode is formed from.

The second(a) electrode and the second(b) electrode may have the same thickness, or the second(a) electrode and the second(b) electrode may have different thicknesses. For example, the thickness of the second(a) electrode may be less than the thickness of the second(b) electrode. In a particular example, the thickness of the second current collector of the second(a) electrode may be less than the thickness of the second current collector of the second(b) electrode. In another example, the thickness of the second active material layer of the second(a) electrode may be less than the thickness of the second active material layer of the second(b) electrode.

The method of manufacturing the electrode assembly according to embodiments of the present disclosure may have improved process efficiency as comparted to other methods of manufacturing electrode assemblies. In the manufacturing method, the first unit cell is bent to allow for insertion of the second unit cell. Accordingly, a plurality of first electrodes, second electrodes, and separators may be formed while one second unit cell is inserted. Accordingly, the stacking speed of the electrodes and separators may increase, and the process time of the electrode assembly may be reduced.

The electrode assembly formed by a manufacturing method according to embodiments of the present disclosure includes the first separator including the bent portion and the second separator not including the bent portion. And the electrode assembly includes the second(a) electrode including the bent portion and the second(b) electrode not including the bent portion. The first separator and the second separator may be formed from different materials, the first separator and the second separator may be different sized, and the second(a) electrode and the second(b) electrode may be formed from different materials. In still further embodiments, the second(a) electrode and the second(b) electrode may be different sized.

Accordingly, the electrode assembly may be easily manufactured and have improved performance.

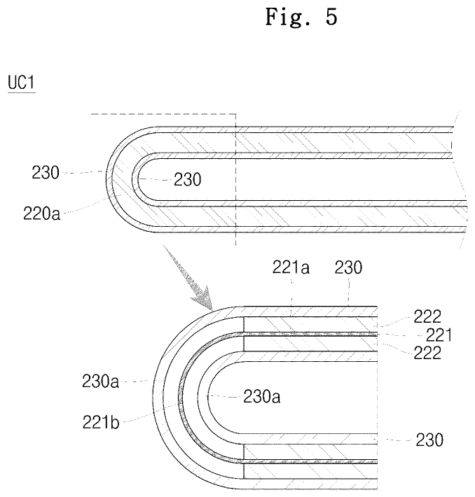

FIGS. 5 to 8 are drawings illustrating various examples of the first unit cell.

Referring to FIG. 5, the first unit cell UC1 may include the second(a) electrode 220a and the separator 230. The second(a) electrode 220a may further include the second current collector 221 and the second active material layer 222. The second active material layer 222 may be disposed on both surfaces of the second current collector 221.

The second current collector 221 may include a straight portion 221a and a bent portion 221b. The bent portion 221b may extend from the straight portion 221a along the bent portion 230a of the separator.

The second active material layer 222 may be disposed in a set region. In particular, the second active material layer 222 may be disposed on the straight portion 221a, and the second active material layer 222 may not be disposed on the bent portion 221b. In another embodiment, the second active material layer 222 may not be disposed on a part of the bent portion 221b. The second active material layer 222 may be disposed only on the straight portion 221a or the second active material layer 222 may be disposed on the straight portion 221a and on a part of the bent portion 221b.

As described above, a crack form in the second active material layer at the bent portion BP of the first unit cell. Accordingly, the second active material layer may not be disposed on the bent portion BP or the second active material layer may be disposed only on a part of the bent portion BP. Thus, it is possible to prevent cracks from being formed in the second active material layer when the first unit cell is bent. And, as the second current collector 221 is disposed on the bent portion BP, the first unit cell can be easily bent.

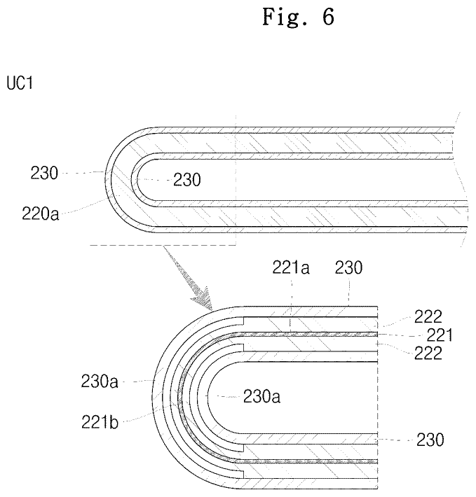

Referring to FIG. 6, the second active material layer 222 may be disposed on the straight portion 221a and the bent portion 221b. The thickness of the second active material layer disposed on the straight portion 221a and the thickness of the second active material layer disposed on the bent portion 221b may be different. For example, the thickness of the second active material layer disposed on the bent portion 221b may be less than the thickness of the second active material layer disposed on the straight portion 221a.

As described above, the second active material layer may be cracked at the bent portion BP of the first unit cell. Accordingly, the thickness of the second active material layer disposed on the bent portion may be less than the thickness of the second active material layer disposed on the flat portion. Accordingly, when the first unit cell is bent, it is possible to prevent the crack from being formed in the second active material layer disposed on the bent portion.

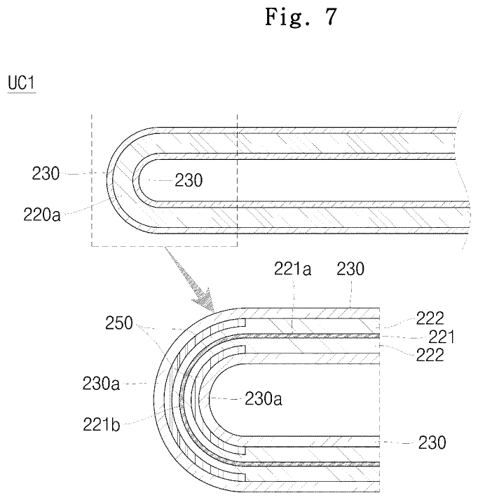

Referring to FIG. 7, the second(a) electrode 220a may further include a protective layer 250 disposed on the second active material layer 222.

The second active material layer 222 may be disposed on the straight portion 221a and the bent portion 221b. Only the second active material layer 222 may be disposed on the straight portion 221a. The second active material layer 222 and the protective layer 250 may be disposed on the bent portion 221b. The protective layer 250 may be disposed on the second active material layer 222.

The protective layer 250 may be formed from a highly elastic material. That is, the protective layer 250 may be an elastic layer. Lithium ions do not move in the bent portion BP of the first unit cell. Thus, even if the protective layer 250 is disposed on the bent portion 221b, it does not affect the movement of lithium ions between the negative electrode and the positive electrode.

As described above, the second active material layer may crack in the bent portion BP of the first unit cell. But, in embodiments of the present disclosure, the thickness of the second active material layer disposed at the bent portion may be less than the thickness of the second active material layer disposed at the straight portion, and the protective layer is disposed on the second active material layer of the bent portion. Accordingly, when the first unit cell is bent, the second active material layer disposed at the bent portion may be protected by the protective layer. Thus, cracking of the second active material layer may be prevented.

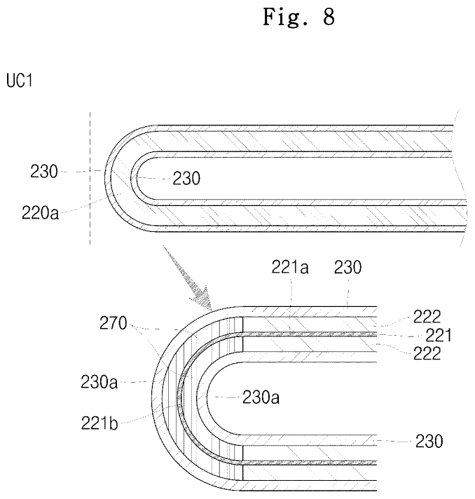

Referring to FIG. 8, the second active material layer 222 may be disposed at the straight portion 221a or the second active material layer 222 may be disposed on the straight portion 221a and may be disposed on a part of the bent portion 221b.

The second(a) electrode 220a may further include a resin layer 270 disposed in the bent portion 221b. The resin layer 270 may extend from the end of the second active material layer 222. The thickness of the resin layer 270 may be less than or equal to the thickness of the second active material layer 222. The resin layer 270 may be formed from a highly elastic material. That is, the resin layer 270 may be an elastic layer.

As described above, the second active material layer may be cracked at the bent portion BP of the first unit cell. Accordingly, the second active material layer may not be disposed at the bent portion BP, or the second active material layer may be disposed only in a portion of the bent portion BP. And the resin layer may be disposed on the bent portion. Accordingly, the step between the straight portion of the second current collector and the bent portion of the second current collector may be reduced or eliminated. Further, cracks may be prevented from forming in the second active material layer when the first unit cell is bent. And the electrode assembly may be easily thermally compressed.

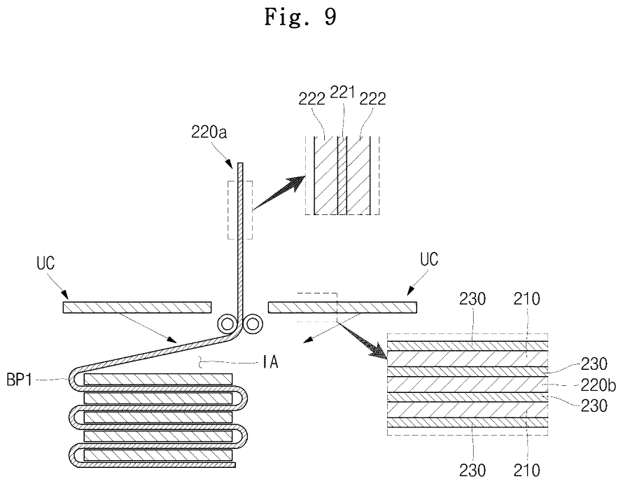

Hereinafter, referring to FIGS. 9 to 14, a method of manufacturing the electrode assembly according to another embodiment and the electrode assembly manufactured thereby will be described. Commonalities with the embodiments described above will be omitted. In addition, the same drawing reference numerals are given to the same configurations as those of the above-described embodiments.

FIG. 9 shows a method of manufacturing the electrode assembly according to another embodiment.

Referring to FIG. 9, a second(a) electrode 220a and a unit cell UC are prepared. The second(a) electrode 220a is wound on a roller. The unit cell UC includes the first electrode 210, the second(b) electrode 220b, and the separator 230. The unit cell UC may have a set thickness. For example, the thickness of the unit cell UC may be 0.3 mm or more. More specifically, the thickness of the unit cell UC may be 0.3 mm to 0.5 mm.

The number of layers of the unit cell UC may be controlled. In detail, the unit cell UC may include a plurality of first electrodes 210, at least one second(b) electrode 220b, and a plurality of separators 230. In an example, the separator 230 is disposed at the lowermost and uppermost portions of the unit cell UC, the separator is disposed between the first electrode 210 and the second(b) electrode 220b.

In a manufacturing process, the second(a) electrode 220a is unwound from the roller while forming a bent portion BP1. The unit cells UC may be provided one by one to the insertion portion IA formed by the folded portion.

The second(a) electrode 220a includes the bent portion BP1, and the unit cell UC includes the second(b) electrode 220b. To prevent cracks in the second active material layer of the second(a) electrode 220a, the bent portion BP1 may have a radius of curvature within a set range. For example, the radius of curvature the bent portion BP1 may be 0.15 mm or more. In more specific examples, the radius of curvature of the bent portion BP1 may be 0.15 mm to 0.25 mm. The radius of curvature of the bent portion BP1 may be determined by the thickness of the unit cell UC. That is, the curvature radius of the bent portion BP1 may be proportional to the thickness of the unit cell UC.

The thickness of the unit cell UC may be 0.3 mm to 0.5 mm. When the thickness of the unit cell UC is less than 0.3 mm, the radius of curvature of the bent portion BP1 is decreased such that cracks may be formed in the second active material layer in the bent portion BP1. When the thickness of the unit cell UC1 is greater than 0.5 mm, the radius of curvature of the bent portion BP1 is increased. But, in such a case, when the second(a) electrode 220a is thermally compressed after the insertion of the unit cell UC is completed, the efficiency of the thermal compression process may be decreased. And the second(a) electrode 220a may be damaged during the thermal compression process.

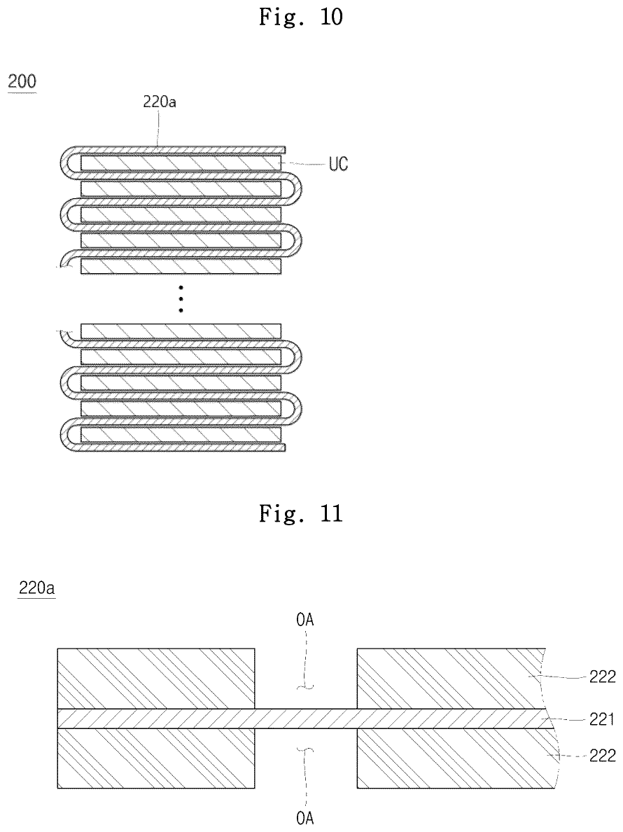

FIG. 10 is the electrode assembly formed by the manufacturing method described above.

The electrode assembly 200 may include different shaped second electrodes. In particular, the electrode assembly 200 may include a second(a) electrode including the bent portion BP1 and a second(b) electrode of the unit cell UC. The second(a) electrode and the second(b) electrode may be formed from the same or different materials. And the second(a) electrode and the second(b) electrode may have the same or different thicknesses. Since the description of the rest of the electrode assembly 200 is the same as that in FIG. 4, further description will be omitted.

FIGS. 11 to 14 are drawings illustrating various examples of the second(a) electrode. In particular, FIGS. 11 to 14 illustrate the second(a) electrode before bending.

Referring to FIG. 11, the second(a) electrode 220a may include a second current collector 221 and a second active material layer 222. The second active material layer 222 may be disposed on both surfaces of the second current collector 221. Further, the second active material layer 222 may be provided in a portion of the second current collector 221 such that an open region OA is formed where the second active material layer 222 is not disposed. The open region OA may be formed on both surfaces of the second current collector 221. The open region OA may be bent when the second(a) electrode is bent. That is, the bent portion BP1 of the second(a) electrode may correspond to the open region OA.

As described above, the second active material layer may crack in the bent portion BP1. Bent, the second(a) electrode includes an open region and the second(a) electrode is bent in the open region, it is possible to prevent the crack from being formed in the second active material layer.

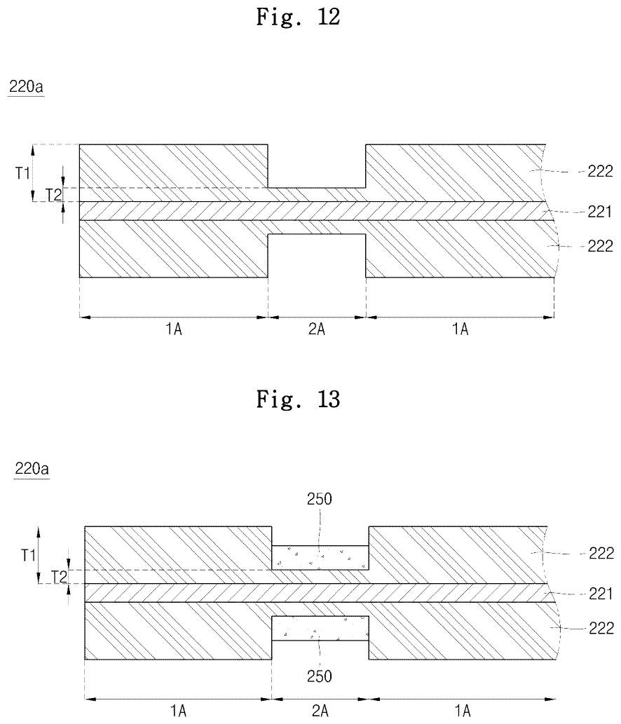

Referring to FIG. 12, the second(a) electrode may include a first region 1A and a second region 2A. The second active material layer 222 may be provided in the first region 1A and the second region 2A. The second active material layer having a first thickness T1 may be provided in the first region 1A, and the second active material layer having a second thickness T2 may be provided in the second region 2A. The second thickness T2 may be less than the first thickness T1.

In a manufacturing process, the second region 2A may be bent as the second(a) electrode is unwound. That is, the bent portion BP1 of the second(a) electrode may correspond to the second region 2A.

As described above, the crack may be formed in the bent portion BP1 of the second active material layer. But, when the thickness of the active material layer on the second region corresponding to the bent portion is small, it is possible to prevent cracks from forming in the second active material layer when the second(a) electrode is bent.

Referring to FIG. 13, the second(a) electrode may include a first region 1A and a second region 2A. The second active material layer 222 may be provided in the first region 1A and the second region 2A. The second active material layer may have a first thickness T1 in the first region 1A, and the second active material layer may have a second thickness T2 in the second region 2A. The second thickness T2 may be less than the first thickness T1.

The second(a) electrode may further include a protective layer 250 disposed on the second active material layer 222 in the second region 2A. The protective layer 250 may include a highly elastic material. That is, the protective layer 250 may be an elastic layer. As described above, the second active material layer may crack when being bent. But when the thickness of the active material layer of the second region corresponding to the bending portion is small, it is possible to prevent cracks from forming in the second active material layer when the second(a) electrode is bent. And, when the protective layer is disposed on the second active material layer of the bent portion, the second active material layer disposed on the bent portion may be protected by the protective layer. Accordingly, cracking of the second active material layer may be prevented by the protective layer.

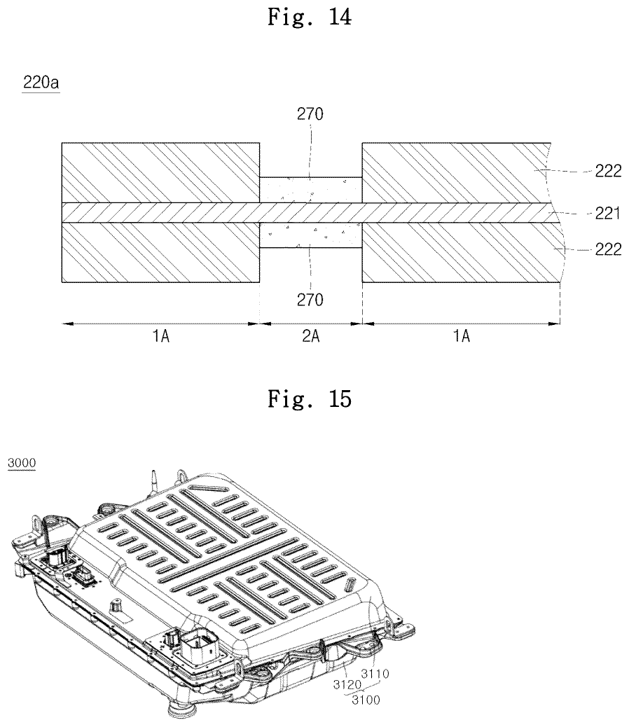

Referring to FIG. 14, the second(a) electrode may include a first region 1A and a second region 2A. The second active material layer 222 may be provided in the first region 1A. The second(a) electrode may further include a resin layer 270 disposed in the second region. The resin layer 270 may extend from an end of the second active material layer 222. The thickness of the resin layer 270 may be less than or equal to the thickness of the second active material layer 222. The resin layer 270 may include a highly elastic material. That is, the resin layer 270 may be an elastic layer.

As described above, the crack may be formed in the second active material layer in the bent portion BP1. To prevent such cracking, the second active material layer may not be provided in the bent portion BP1, and the resin layer may be provided in the bent portion. Accordingly, the step between the first region and the second region may be reduced or eliminated. Accordingly, it is possible to prevent the crack from being formed in the second active material layer when the first electrode is bent, and the electrode assembly may be easily thermally compressed.

A secondary battery according to embodiments of the present disclosure may be used in portable small electronic devices such as smartphones, feature phones, notebook computers, digital cameras, and camcorders. A battery module and a battery pack including a plurality of secondary batteries according to the present disclosure may be used as a power source for driving a motor of a hybrid vehicle or an electric vehicle and as a battery for storing power. The plurality of secondary batteries in a battery module may be connected to each other in series, parallel, or series/parallel by a bus bar.

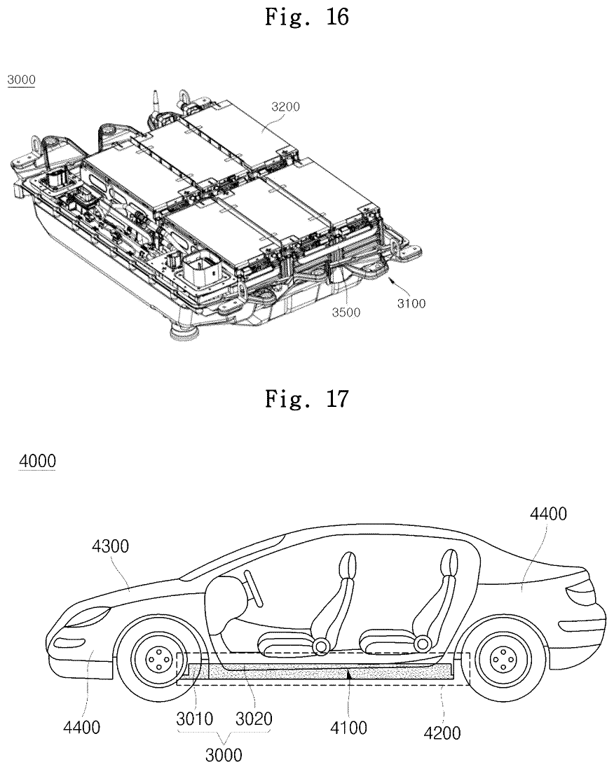

FIGS. 15 and 16 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 17, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

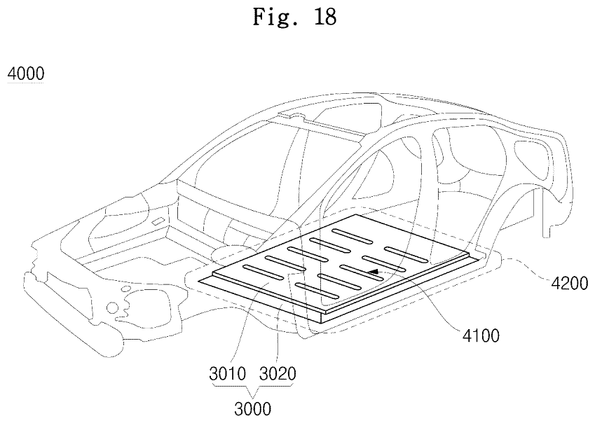

In FIG. 18, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. An electrode assembly comprising:
a first unit cell comprising a plurality of insert portions formed by a plurality of bent portions; and
a plurality of second unit cells, each of the second unit cells being provided to one of the insert portions,
wherein the first unit cell comprises a second(a) electrode as a negative electrode and a separator disposed on both surfaces of the second(a) electrode,
wherein each of the second unit cells comprises a plurality of first electrodes as positive electrodes, at least one second(b) electrode as a negative electrode, and a plurality of separators, and
wherein the second unit cells have a thickness of 0.3 mm to 0.5 mm.

2. The electrode assembly as claimed in claim 1, wherein a radius of curvature of the bent portion is 0.15 mm to 0.25 mm.

3. The electrode assembly as claimed in claim 1, wherein shapes of the separator of the first unit cell and the separators of the second unit cells are different.

4. The electrode assembly as claimed in claim 1, wherein the separator of the first unit cell and the separators of the second unit cells comprise different materials.

5. The electrode assembly as claimed in claim 1, wherein the separators of the first unit cell and the separator of the second unit cells have different thicknesses.

6. The electrode assembly as claimed in claim 1, wherein the second(a) electrode and the second(b) electrodes comprise different materials.

7. The electrode assembly as claimed in claim 1, wherein the second(a) electrode and the second(b) electrodes have different thicknesses.

8. The electrode assembly as claimed in claim 1, wherein the second(a) electrode comprises a current collector and an active material layer disposed on surfaces of the current collector,
wherein the current collector comprises a straight portion and a bent portion, and
wherein the active material layer is disposed on the straight portion.

9. The electrode assembly as claimed in claim 8, wherein the active material layer is disposed in a part of the bent portion.

10. The electrode assembly as claimed in claim 1, wherein the second(a) electrode comprises a current collector and an active material layer on surfaces of the current collector,
wherein the current collector comprises a straight portion and a bent portion,
wherein the active material layer is disposed on the straight portion and the bent portion, and
wherein a thickness of the second active material layer disposed on the bent portion is less than a thickness of the second active material layer disposed on the straight portion.

11. The electrode assembly as claimed in claim 10, wherein the second(a) electrode further comprises a protective layer on the second active material layer that is disposed on the bent portion.

12. The electrode assembly as claimed in claim 1, wherein the second(a) electrode comprises a current collector, with an active material layer and a resin layer being formed on surfaces of the current collector,
wherein the current collector comprises a straight portion and a bent portion,
wherein the active material layer is disposed on the straight portion, and
wherein the resin layer is disposed on the bent portion.

13. An electrode assembly comprising:
a plurality of unit cells each including a plurality of first electrodes, at least one second(b) electrode, and a plurality of separators, with the first electrodes being positive electrodes, and
a second(a) electrode including a plurality of insert portions formed by a plurality of bent portions, the second electrode(a) being a negative electrode,
wherein each of the unit cells is inserted to one of the insert portions of the second(a) electrode, and
wherein thicknesses of the unit cells are 0.3 mm to 0.5 mm.

14. The electrode assembly as claimed in claim 13, wherein a radius of curvature of each of the bent portions is 0.15 mm to 0.25 mm.

15. The electrode assembly as claimed in claim 13, wherein the second(a) electrode and the second(b) electrodes comprise different materials.

16. The electrode assembly as claimed in claim 13, wherein the second(a) electrode and the second(b) electrodes have different thicknesses.

17. The electrode assembly as claimed in claim 13, wherein the second(a) electrode comprises a current collector and an active material layer disposed on surfaces of the current collector,
wherein the second(a) electrode comprises an open region where the active material layer is not disposed, and
wherein the second(a) electrode is bent in the open region.

18. The electrode assembly as claimed in claim 13, wherein the second(a) electrode comprises a current collector, and an active material layer disposed on surfaces of the current collector,
wherein the second(a) electrode comprises a first region and a second region,
wherein the active material layer has a first thickness on the first region,
wherein the active material layer has a second thickness on the second region,
wherein the second thickness is less than the first thickness, and
wherein the second(a) electrode is bent in the second region.

19. The electrode assembly as claimed in claim 13, wherein the second(a) electrode further comprises a protective layer on the active material layer on the second region.

20. The electrode assembly as claimed in claim 13, wherein the second(a) electrode comprises a current collector, and an active material layer and a resin layer being formed on surfaces of the current collector,
wherein the second(a) electrode comprises a first region and a second region,
wherein the active material layer is disposed on the first region,
wherein the resin layer is disposed on the second region, and
wherein the second(a) electrode is bent in the second region.
